(19) United States
(12) Patent Application Publication
(10) Pub. No.: US 2007/0017789 A1
(43) Pub. Date: Jan. 25, 2007

(54) Spring-loaded locking dial for hair appliances

(76) Inventor: Kenneth C. Russo, Westport, CT (US)

Correspondence Address: STEVEN A. GARNER, ESQ.;CONAIR CORPORATION, ONE CUMMINGS POINT ROAD, STAMFORD, CT, 06902, US

(21) Appl. No.: 11/491,687

(22) Filed: Jul. 24, 2006

Related U.S. Application Data
(60) Provisional application No. 60/701,821, filed on Jul. 22, 2005.

(51) Int. Cl. H01H 43/10

(52) U.S. Cl. 200/38 A

(57) ABSTRACT

A rotatably mounted control dial has two axial positions: a depressed, locked position, and an extended, unlocked position. A user can selectively lock and unlock the dial by pressing on it to activate or de-activate a spring-loaded latch.

### CROSS-REFERENCE TO RELATED APPLICATIONS

This application claims priority to U.S. Provisional Patent Application Ser. No. 60/701,821 filed on Jul. 22, 2005, incorporated herein by reference in its entirety.

### BACKGROUND OF THE INVENTION

1. Field of the Invention

The present invention relates to a hair appliance and, more particularly, to a spring-loaded locking dial for controlling functions of a hair appliance such as, but not limited to, styling irons.

2. Description of Related Art

Know hair appliances, particularly styling irons such as flat irons or curling irons, have control dials that are generally round and rotatably mounted on the exterior housing for adjusting heat settings on irons. Such dials are susceptible to being inadvertently moved by the user's fingers or thumb during use as the appliance is held on one hand. Also, such dials tend to protrude beyond the exterior surface of the appliance in order to be physically accessed.

### OBJECTS AND BRIEF SUMMARY OF THE INVENTION

It is desirable to provide a control dial for a handheld hair appliance such as a styling iron in which the dial is not susceptible to inadvertent movement and does not protrude substantially beyond the housing surface of the appliance. These and other objects are achieved by the present invention.

The present invention relates to a rotatably mounted control dial having two axial positions: a depressed, locked position, and an extended, unlocked position. A user can selectively lock and unlock the dial by pressing on it to activate or de-activate a spring-loaded latch.

### BRIEF DESCRIPTION OF THE DRAWINGS

FIG. 1 is a top view of a control dial for a hair appliance according to the present invention.

FIGS. 2A-2F are partial, cross-sectional views of the control dial according to the present invention shown in various modes.

### DETAILED DESCRIPTION OF THE INVENTION

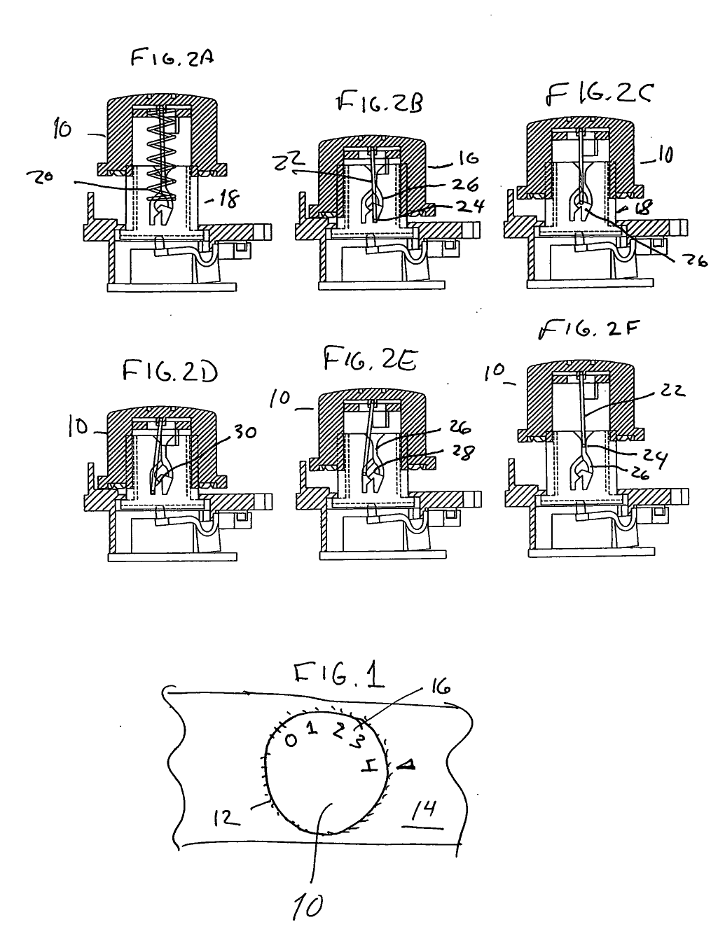

Referring to FIG. 1, a control dial (10) has a round exterior surface (12) and is mounted for rotation relative to a housing (14) of an appliance, such as a styling iron. The dial (10) may have indicia (16) such as numerals or other marks indicating various operational settings.

In operation, the dial (10) is in an un-locked position as shown in FIG. 2A, where the dial (10) is telescopically extended from an inner sleeve (18). A spring (20) biases the dial (10) into this unlocked position, where the dial (10) is free to rotate. When a user depresses the dial (10) against the spring (20) force to a position as shown in FIG. 2B, an internal wire (22) having a hooked end (24) rides inside a channel (26) to the lower-most, right hand side position, as shown in FIG. 2B. FIGS. 2B-2F are shown without the spring (20) for purposes of clarity. When the user releases the dial (10), the spring (20) causes it to move up to the position of FIG. 2C, where the wire end (24) locks up into a corner (28) of the channel (26). In this position, the dial (10) is unable to rotate. To unlock the dial (10), the user pushes the dial (10) downwardly and the wire end (24) moves to the lower-most, left hand side position as shown in FIG. 2D, due to the cam surface (30) in the channel (26). When the user releases pressure on the dial (10), the spring (20) causes it to move up as shown in FIG. 2E until it reaches the unlocked position of FIG. 2F, which is the same as FIG. 2A (but with the spring not shown for clarity).

With this type of locking mechanism for a dial, various electrical contacts and switches can be implemented such as those known to those skilled in the art. While the preferred embodiment has been shown and described, it is contemplated that various modification can be made without departing from the scope of the present invention.

What is claimed is:

1. A control dial for a hair appliance comprising:
a first portion attached to a hair appliance housing;
a second portion movably connected to said first portion; and
a spring adapted to bias said second portion away from said first portion.

2. A control dial according to claim 1, wherein
said second portion is telescopically connected to said first portion.

3. A control dial according to claim 1, further comprising
an internal wire; and
a channel to guide said internal wire to enable a user to control the movement of the control dial.

4. A control dial according to claim 3, wherein
said internal wire further comprises a hooked end.

5. A control dial according to claim 4, wherein
said channel further comprises a corner to catch said hooked end to prevent said second portion from moving away from said first portion.

6. A control dial according to claim 5, wherein
said second portion is in a first position when said hooked end is not caught in said corner and a second position when said hooked end is caught in said corner.

7. A control dial according to claim 6, wherein
said control dial is extended from said housing and able to be rotated when in said first position.

8. A control dial according to claim 6, wherein
said control dial is flush with said housing and unable to be rotated when in said second position.
